(19) United States
(12) Patent Application Publication
(10) Pub. No.: US 2025/0289693 A1
(43) Pub. Date: Sep. 18, 2025

(54) Load Transport System

(71) Applicant: Challenger Group, LLC, Columbus, NC (US)

(72) Inventors: Merle Duane Stoltzfus, Columbus, NC (US); Marlin Jay Stoltzfus, Chuckey, TN (US)

(73) Assignee: Challenger Group, LLC, Columbus, NC (US)

(21) Appl. No.: 19/083,193

(22) Filed: Mar. 18, 2025

Related U.S. Application Data
(60) Provisional application No. 63/566,635, filed on Mar. 18, 2024.

(51) Int. Cl. B66F 9/075; B66F 9/08; B66F 9/12; B66F 9/14; B66F 9/22

(52) U.S. Cl. CPC B66F 9/07581; B66F 9/07559; B66F 9/082; B66F 9/125; B66F 9/141; B66F 9/149; B66F 9/22

(57) ABSTRACT

A vehicle including a propulsion mechanism operable to propel the vehicle for travel thereof; a base coupled to the propulsion mechanism; an upright movably coupled to the base, whereby the upright can be movable upwardly and downwardly relative to the base; and an engagement element movably coupled to the upright, whereby the engagement element can be movable upwardly and downwardly relative to the upright. As to particular embodiments, the inventive vehicle can be configured as a forklift. Following, the engagement element can be configured as a fork having one or more prongs suitable for engaging with a load, whereby the forklift may be useful for lifting and transporting the load from one location to another location.

### I. SUMMARY OF THE INVENTION

A broad object of a particular embodiment of the invention can be to provide a vehicle including a propulsion mechanism operable to propel the vehicle for travel thereof; a base coupled to the propulsion mechanism; an upright movably coupled to the base, whereby the upright can be movable upwardly and downwardly relative to the base; and an engagement element movably coupled to the upright, whereby the engagement element can be movable upwardly and downwardly relative to the upright. As to particular embodiments, the inventive vehicle can be configured as a forklift. Following, the engagement element can be configured as a fork having one or more prongs suitable for engaging with a load, whereby the forklift may be useful for lifting and transporting the load from one location to another location.

Naturally, further objects of the invention are disclosed throughout other areas of the specification, drawings, and claims.

### II. BRIEF DESCRIPTION OF THE DRAWINGS

FIG. 1A is a perspective view of a particular embodiment of the inventive vehicle suitable for transporting a load.

FIG. 1B is a front view of the particular embodiment of the vehicle shown in FIG. 1A.

FIG. 1C is a rear view of the particular embodiment of the vehicle shown in FIG. 1A.

FIG. 1D is a left view of the particular embodiment of the vehicle shown in FIG. 1A.

FIG. 1E is a right view of the particular embodiment of the vehicle shown in FIG. 1A.

FIG. 1F is a top view of the particular embodiment of the vehicle shown in FIG. 1A.

FIG. 1G is a bottom view of the particular embodiment of the vehicle shown in FIG. 1A.

FIG. 2A is a perspective view of a particular embodiment of the inventive vehicle in which the base disposes in a base forward position, the upright disposes in an upright lower position, and the fork disposes upwardly.

FIG. 2B is a perspective view of a particular embodiment of the inventive vehicle in which the base disposes in a base forward position, the upright disposes upwardly, and the fork disposes downwardly.

FIG. 3A is a perspective view of a particular embodiment of the inventive vehicle in which the base disposes in a base rearward position, the upright disposes in an upright lower position, and the fork disposes upwardly.

FIG. 3B is a perspective view of a particular embodiment of the inventive vehicle in which the base disposes in a base rearward position, the upright disposes upwardly, and the fork disposes downwardly.

FIG. 4A is a perspective view of a particular embodiment of the inventive vehicle in which the fork is shown tilted to the right.

FIG. 4B is a perspective view of a particular embodiment of the inventive vehicle in which the fork is shown tilted to the left.

FIG. 5A is a perspective view of a particular embodiment of the inventive vehicle in which the fork is shown rotated to the right and its prongs dispose proximate the base.

FIG. 5B is a perspective view of a particular embodiment of the inventive vehicle in which the fork is shown rotated to the right and its prongs dispose upwardly and distal from the base.

FIG. 5C is a perspective view of a particular embodiment of the inventive vehicle in which the fork is shown rotated to the left and its prongs dispose proximate the base.

FIG. 5D is a perspective view of a particular embodiment of the inventive vehicle in which the fork is shown rotated to the left and its prongs dispose upwardly and distal from the base.

FIG. 6A is a perspective view of a particular embodiment of the inventive vehicle in which the fork is shown tilted forwardly.

FIG. 6B is a perspective view of a particular embodiment of the inventive vehicle in which the fork is shown tilted backwardly.

FIG. 7A is an exploded perspective view of components of a particular embodiment of the inventive vehicle.

FIG. 7B is a left view of the components of the particular embodiment of the inventive vehicle shown in FIG. 7A.

FIG. 8A is an exploded perspective view of components of a particular embodiment of the inventive vehicle.

FIG. 8B is a left view of the components of the particular embodiment of the inventive vehicle shown in FIG. 8A.

FIG. 9 is a left view of a particular embodiment of the inventive vehicle showing the upright first driver, the upright second driver, and the upright third driver.

FIG. 10A is a perspective view of a particular embodiment of the inventive vehicle suitable for transporting a load.

FIG. 10B is a front view of the particular embodiment of the vehicle shown in FIG. 10A.

FIG. 10C is a rear view of the particular embodiment of the vehicle shown in FIG. 10A.

FIG. 10D is a left view of the particular embodiment of the vehicle shown in FIG. 10A.

FIG. 10E is a right view of the particular embodiment of the vehicle shown in FIG. 10A.

FIG. 10F is a top view of the particular embodiment of the vehicle shown in FIG. 10A.

FIG. 10G is a bottom view of the particular embodiment of the vehicle shown in FIG. 10A.

### III. DETAILED DESCRIPTION OF THE PREFERRED EMBODIMENTS

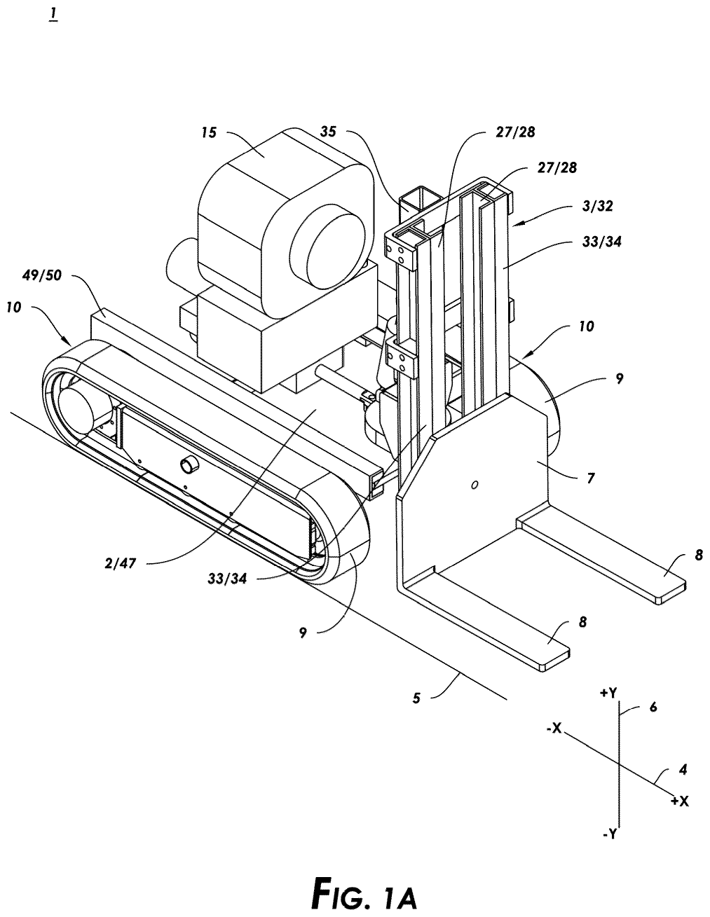

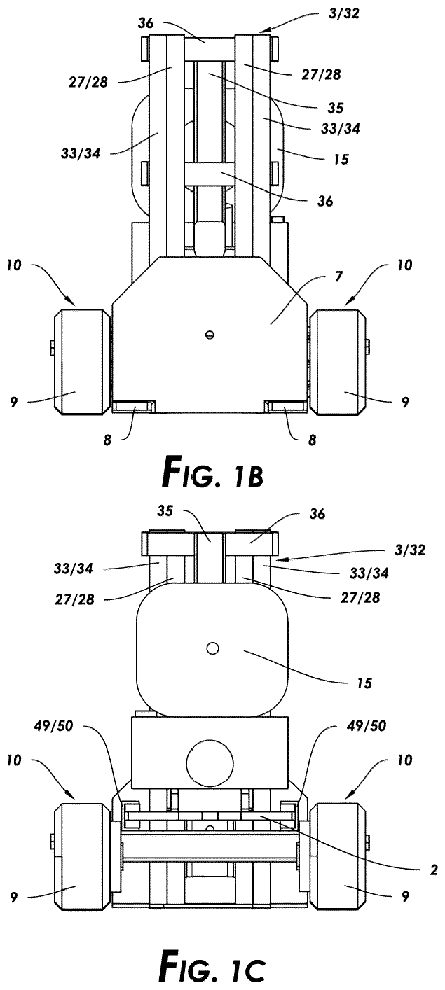

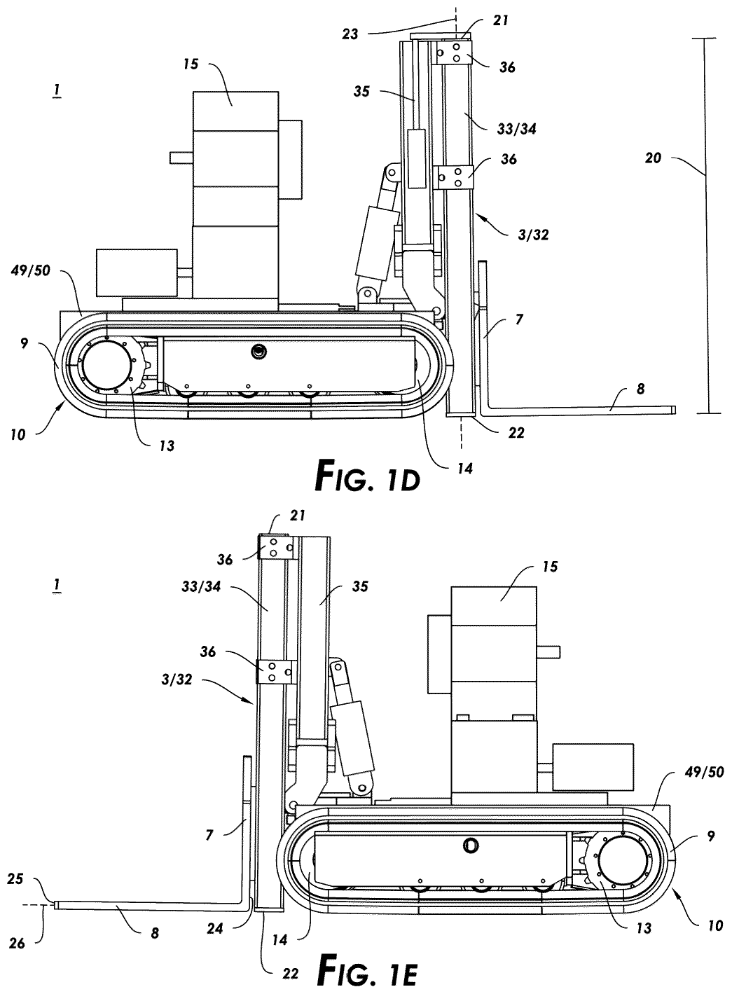

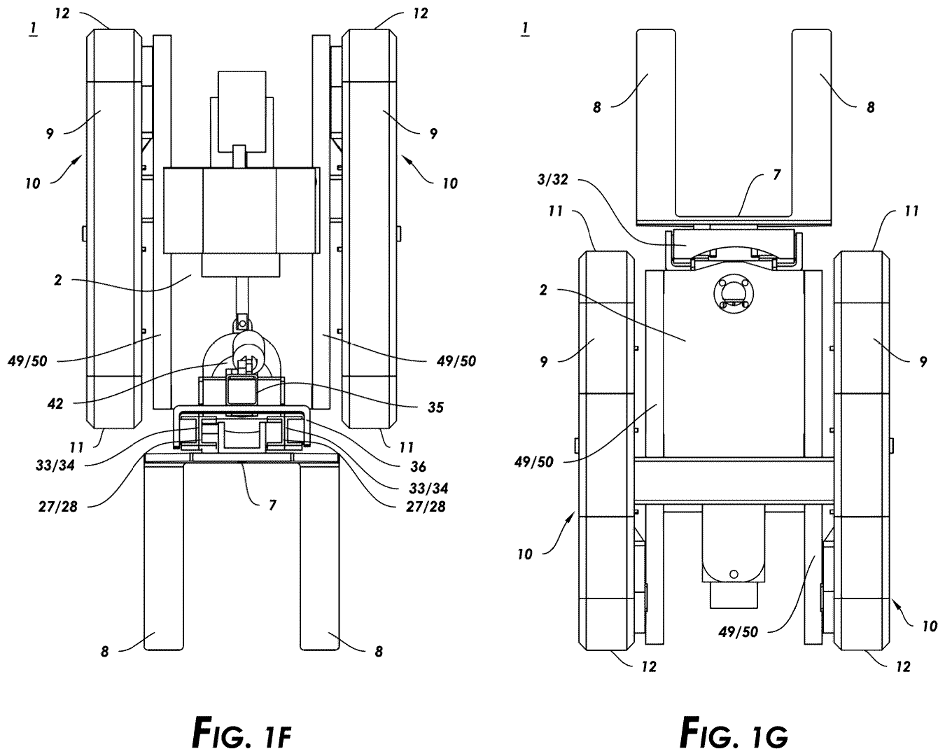

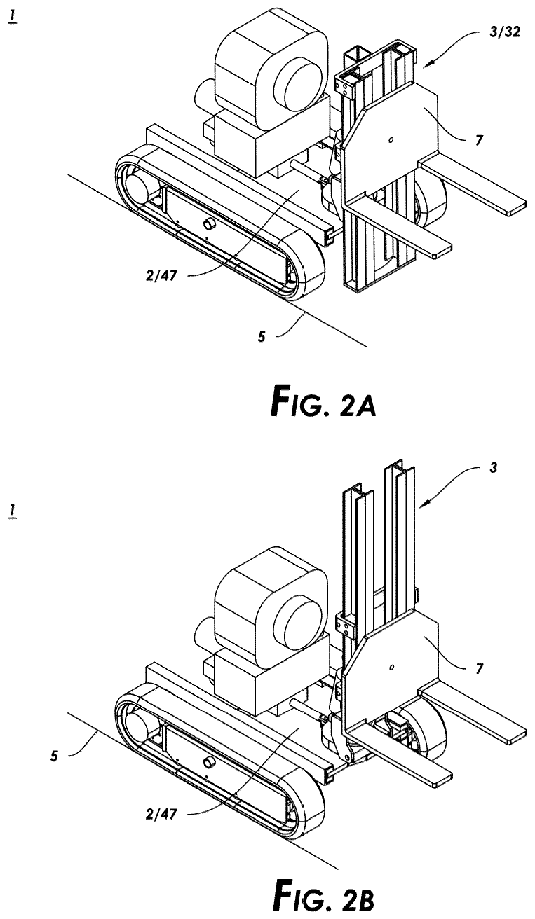

Now referring primarily to FIGS. 1A through 6B, particular embodiments of the inventive vehicle (1) are shown, whereby the vehicle (1) comprises a base (2) coupled to a propulsion mechanism; an upright (3) movably coupled to the base (2), whereby the upright (3) can be movable upwardly and downwardly relative to the base (2); and an engagement element movably coupled to the upright (3), whereby the engagement element can be movable upwardly and downwardly relative to the upright (3). The vehicle (1) can have any of a numerous and wide variety of configurations and dimensions suitable for transporting goods, herein referred to as a load.

Now referring primarily to FIG. 1A, as an XY frame of reference for some embodiments of the present invention, an X axis (4) extends in substantially parallel relation to the ground (5) (or surface upon which the vehicle (1) travels) and correspondingly, substantially horizontally. Forward movement can be considered in a +X direction and backward movement can be considered in a −X direction. A Y axis (6) extends in substantially perpendicular relation to the X axis (4) and the ground (5) and correspondingly, substantially vertically. Upward movement can be considered in a +Y direction and downward movement can be considered in a −Y direction.

Movement of components of the vehicle (1) will be described below. As used herein, “translation” and “translational movement” involve the linear motion of an object in which all points on the object move in the same direction by the same amount; thus, all points on the object undergo the same displacement, and the object as a whole moves from one location to another location. “Rotation” and “rotational movement” involve the pivoting or turning of an object around a rotation axis, whereby different points on the object undergo different displacements as they move in circular paths about the rotation axis.

As to particular embodiments, the inventive vehicle (1) can, but need not necessarily, be configured as a forklift. Following, the engagement element can be configured as a fork (7) having one or more prongs (8) suitable for engaging with a load, whereby the forklift may be useful for lifting and transporting the load from one location to another location. Of note, while the engagement element may be shown and described herein as a fork (7), the engagement element is not limited to such a configuration and can be any of a numerous and wide variety of engagement elements (such as grips, hooks, magnets, etc.) suitable for engaging with a load for subsequent movement thereof.

As to particular embodiments, the forklift can be specifically configured for lifting and transporting heavy, large, and/or bulky objects, for example prefabricated buildings (such as sheds or outbuildings), dumpsters, cargo containers, etc. Advantageously, the forklift can have superior loading capacity, stability, and ease of maneuvering both during loading and unloading operations as well as during transporting operations of such sizeable loads.

As to particular embodiments, the forklift can (but need not necessarily) be an unmanned forklift, for example a remotely controlled forklift which may include a remote control system (e.g., radio, infrared, cable, etc.) with a control unit or transmitter operated by an operator physically removed from the forklift.

Now referring primarily to FIGS. 1A through 1G, the inventive vehicle (1) comprises a base (2) coupled to a ground-engaging propulsion mechanism which propels the base (2) on the ground (5) for travel of the vehicle (1) in a desired direction. As non-limiting examples, the propulsion mechanism can comprise wheels (thus providing a wheeled vehicle, not shown), and/or tracks (9) (thus providing a tracked vehicle).

Regarding the latter, tracks (9) can provide a relatively wide and stable mobile platform for movement of the base (2). Structurally, a tracked vehicle can include a track assembly (10) having one or more continuous (or endless) tracks (9) or treads for propulsion, whereby a track (9) can follow a track travel path disposed between track assembly front and rear ends (11)(12). As to particular embodiments, the inventive vehicle (1) can include a pair of elongate tracks (9), each trained around a drive sprocket (13) and a tension sprocket (14), whereby both sprockets (13)(14) can rotate relative to the base (2).

A powered travel driver (15), such as a motor, can be operably coupled to each drive sprocket (13) to drive rotation thereof and correspondingly, rotation of the tension sprocket (14) and travel of the track (9) around the drive and tension sprockets (13)(14) along the track travel path. Of course, such travel of the track (9) propels the vehicle (1) for travel thereof, whether forward (or in a +X direction) or backward (or in a −X direction). The travel driver (15) can be powered by electricity, fossil fuel, hydraulic power, etc., depending upon the embodiment.

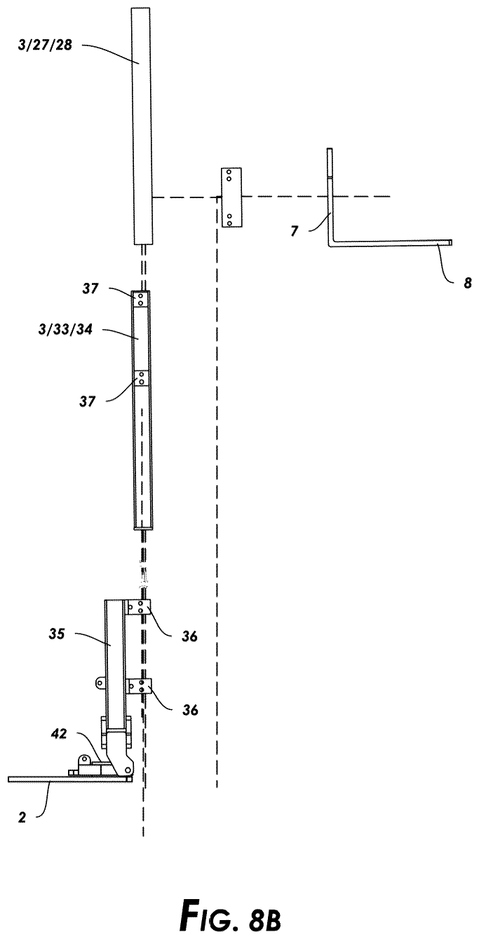

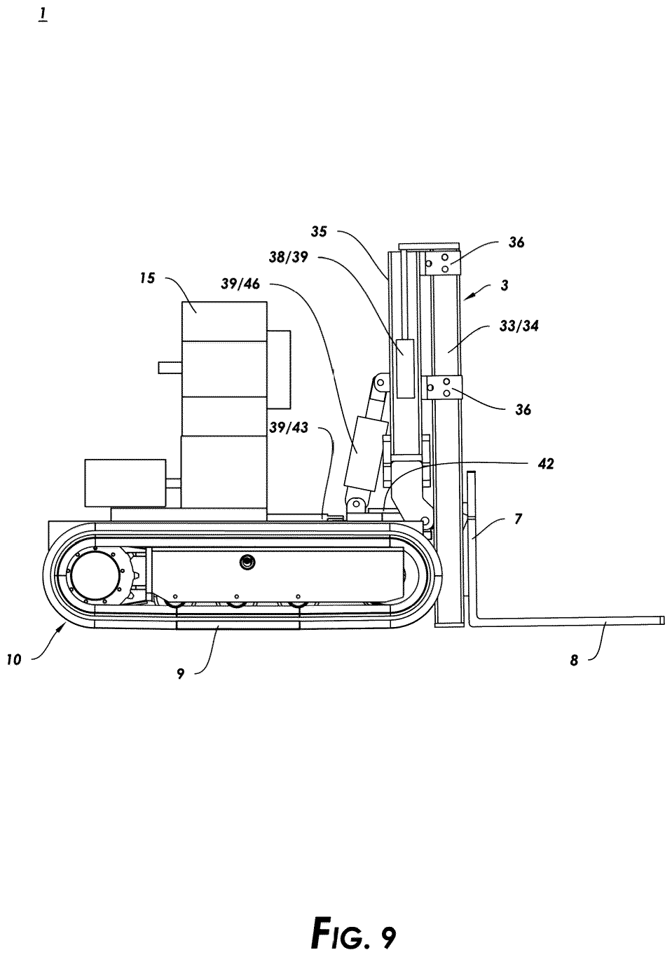

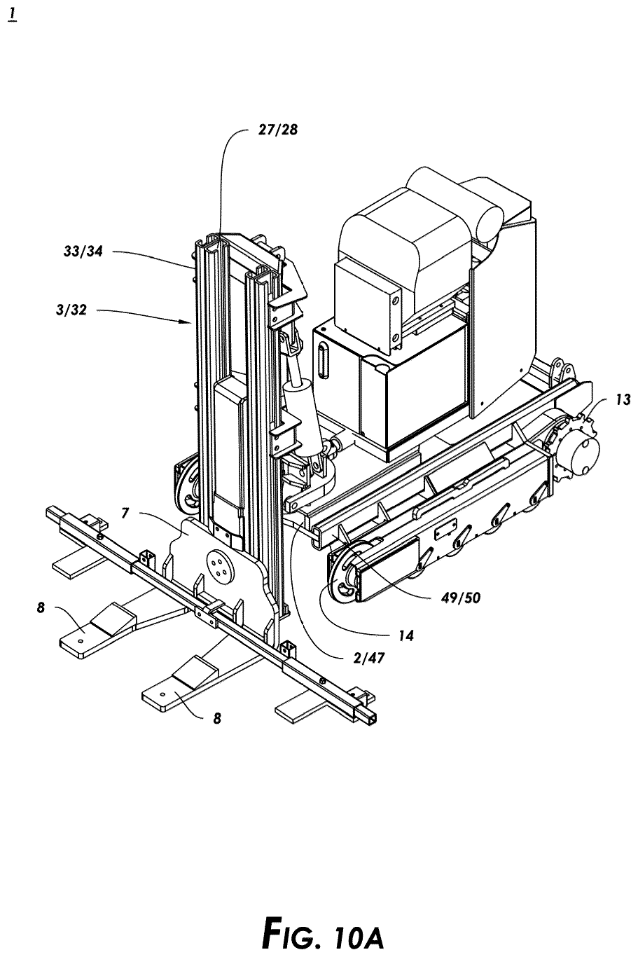

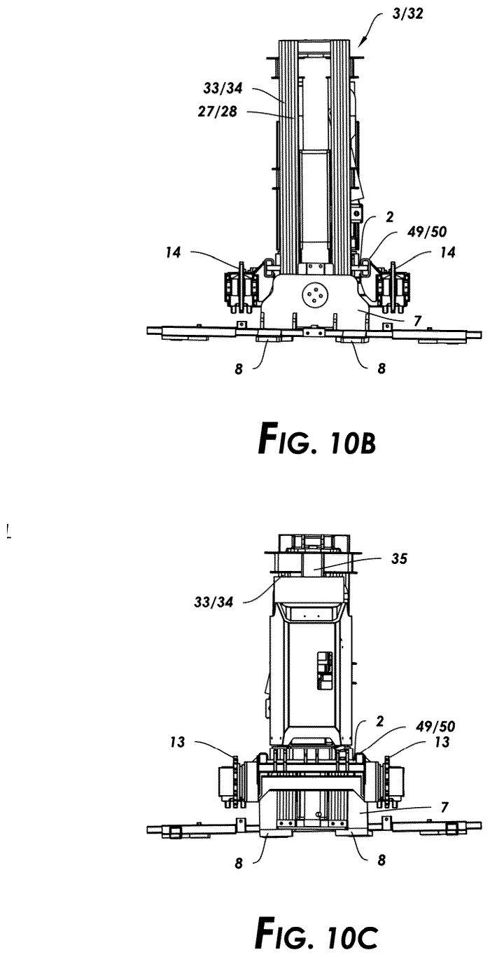

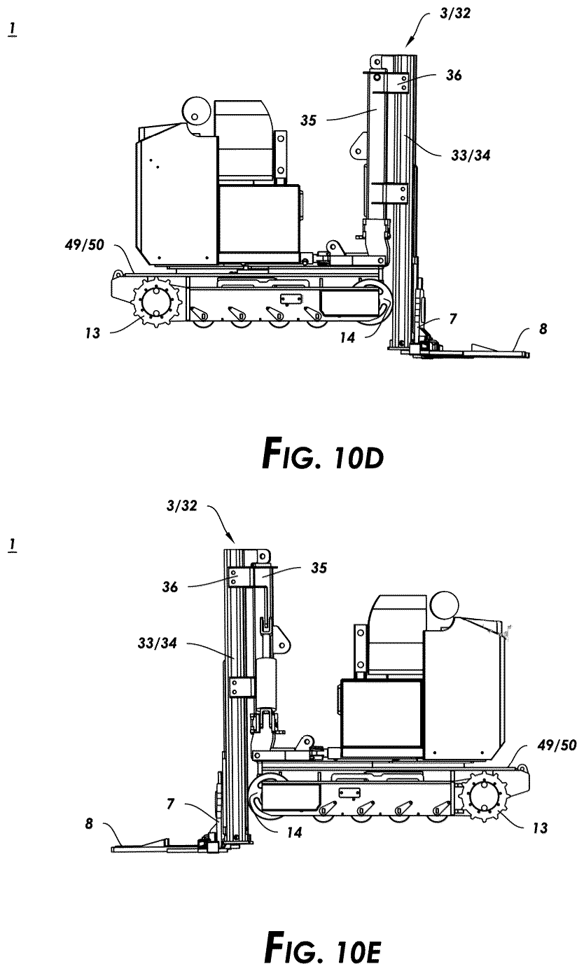

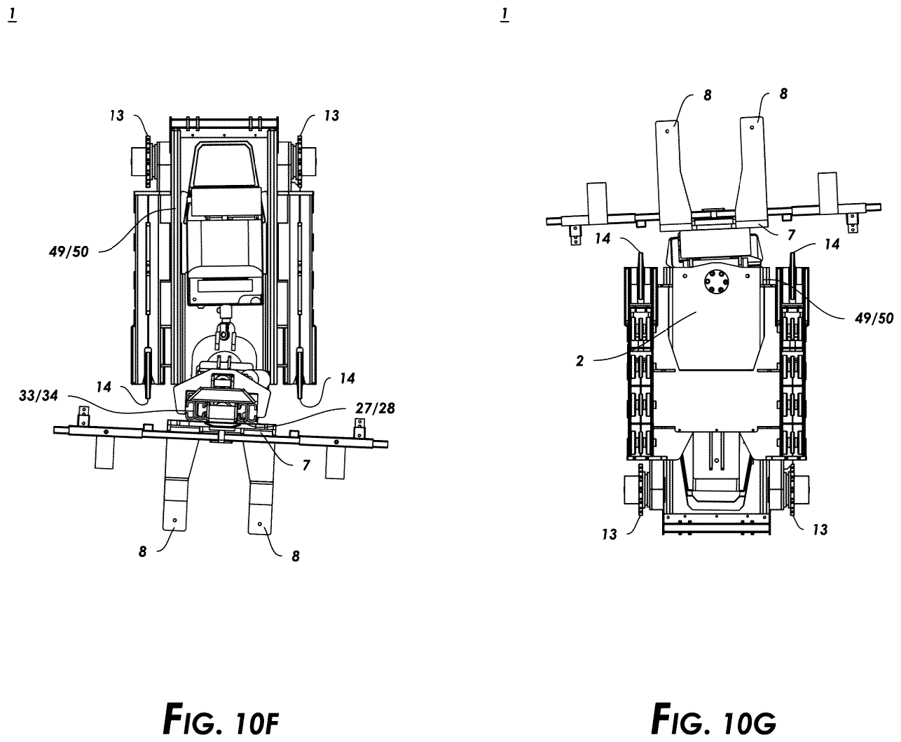

Now referring primarily to FIG. 8A, the base (2) (such as a platform, chassis, or the like) can have a base length disposed between base front and rear ends (16)(17). Typically, the fork (7) disposes proximate the base front end (16) and a track assembly (10) disposes on each of the opposing base sides (18), thus centering the base (2) between the track assemblies (10). A base longitudinal axis (19) extends along the base length, the base longitudinal axis (19) typically extending in substantially parallel relation to the X axis (4).

Now referring primarily to FIGS. 1A through 1G, the vehicle (1) further includes an upright (3) (or mast) coupled to the base (2) (typically proximate the base front end (16)), whereby the upright (3) can have an upright length (20) disposed between upright top and bottom ends (21)(22). An upright longitudinal axis (23) extends along the upright length (20), the upright longitudinal axis (23) typically extending in substantially parallel relation to the Y axis (6) and correspondingly, in substantially perpendicular relation to the X axis (4).

The upright (3) can support a fork (7) extending in a forward direction therefrom. Specifically, a fork proximal end (24) can be coupled to the upright (3) and a fork distal end (25) can outwardly extend therefrom in the +X direction. A fork longitudinal axis (26) passes through the fork proximal and distal ends (24)(25), the fork longitudinal axis (26) typically extending in substantially parallel relation to the X axis (4). Additionally, the fork longitudinal axis (26) can extend in substantially perpendicular relation to the upright longitudinal axis (23).

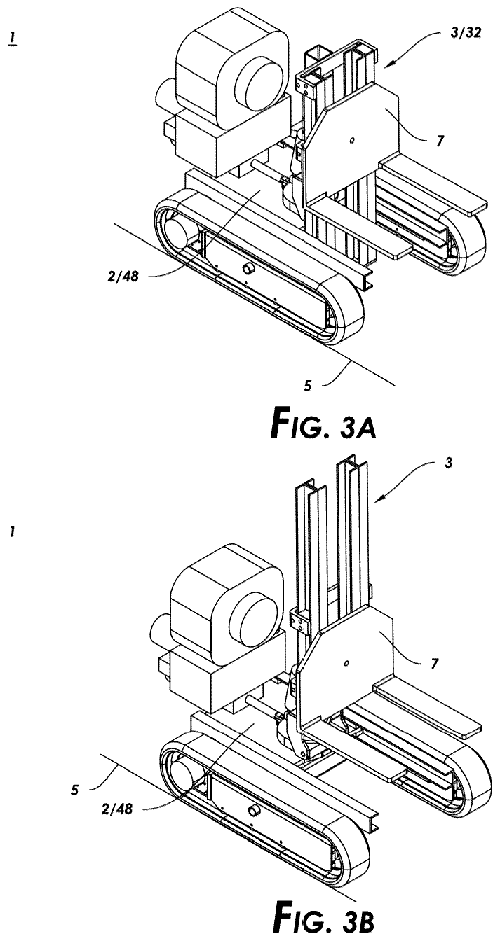

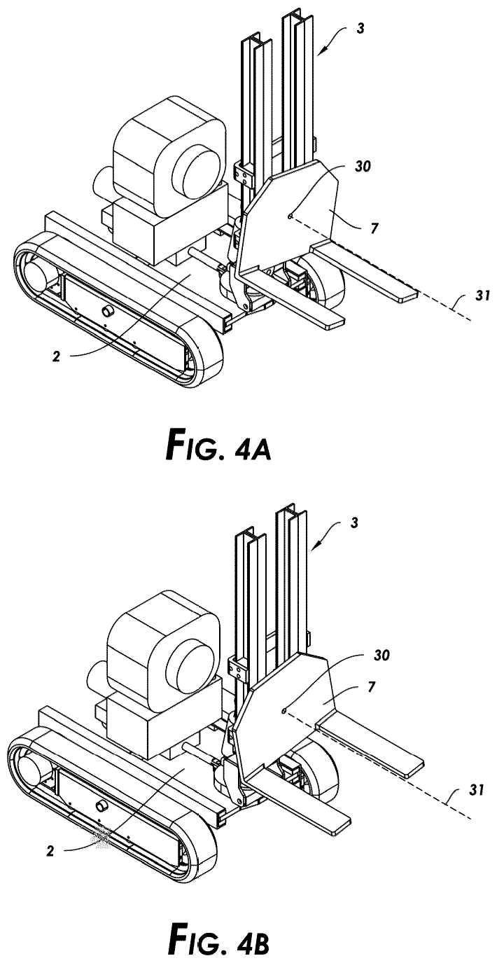

Now referring primarily to FIGS. 2A through 3B, the fork (7) can be movably coupled to the upright (3) such that the fork (7) can translationally move upwardly and downwardly relative to the upright (3) and correspondingly, along the Y axis (6). In this way, the fork (7) can be raised or moved in the +Y direction (as shown in FIGS. 2A and 3A) and lowered or moved in the −Y direction (as shown in FIGS. 2B and 3B) with respect to the ground (5).

As to particular embodiments, the fork (7) can be slidably coupled to the upright (3) such that the fork (7) can slide upwardly and downwardly relative to the upright (3) for raising and lowering with respect to the ground (5). For such sliding movement, the upright (3) can include one or more fork guides (27) disposed along the upright length (20). As to particular embodiments, the upright (3) can include a pair of fork guides (27) disposed along the upright length (20) in substantially parallel spaced-apart relation, whereby the fork guides (27) can extend in substantially parallel relation to the Y axis (6). Hence, the upright (3) can be configured to have a pair of opposing first elongate members (28), each including a fork guide (27) disposed along its length. As but one illustrative, nonlimiting example, each first elongate member (28) can have a generally rectangular, C-shaped cross section with the open side providing a fork guide (27) configured as a first channel, whereby the first channels of each of the two first elongate members (28) can face toward one another. Of course, outwardly, frontwardly, and backwardly facing first channels are also herein contemplated.

The fork (7) can be slidably coupled to the first channels via first bearings (29) or other suitable couplers which travel within the first channels to enable translational movement of the fork (7), for example to raise (or lift) the load via upward movement or lower the load via downward movement. Such translational movement of the fork (7) can be actuated by a powered fork first driver (not shown) which drives the fork (7) to slide via the first channels along the Y axis (6). As to particular embodiments, the fork first driver can be configured as a hydraulic system including hydraulic fluid supplied by a hydraulic reservoir and pressurized by a hydraulic pump. The pressurized hydraulic fluid can be pumped to a hydraulic cylinder to actuate sliding of the fork (7) relative to the upright (3) for movement thereof in the +Y direction or −Y direction.

As to particular embodiments, translational movement of the fork (7) can be actuated by a double-acting hydraulic cylinder which uses hydraulic pressure to move a piston in two directions for both extension and retraction. This may be in contrast to the lifting systems of conventional forklifts which typically employ a single-acting hydraulic cylinder that relies on a return spring, the load, and/or gravity to retract the piston. Supply lines, pressure regulators, valves, etc. may be included in the hydraulic system, as required.

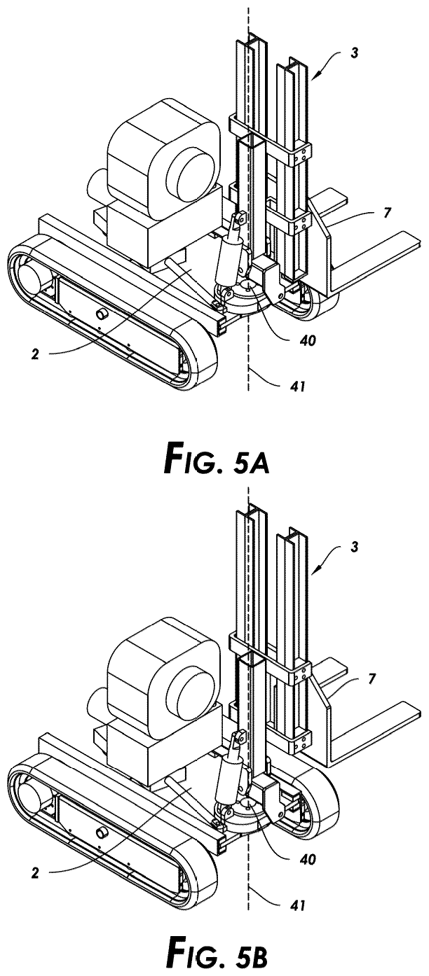

Now referring primarily to FIGS. 4A and 4B, in addition to being movably coupled to the upright (3) such that the fork (7) can translationally move upwardly and downwardly relative to the upright (3), as to particular embodiments, the fork (7) can further be movably coupled to the upright (3) via a first pivot (30) such that the fork (7) can rotate relative to the upright (3) about a fork rotation axis (31) which can typically extend in substantially parallel relation to the fork longitudinal axis (26). Further, the fork rotation axis (31) can extend in substantially parallel relation to the X axis (4). As such, the fork (7) can rotate relative to the upright (3) about the fork rotation axis (31) in both clockwise and counterclockwise directions to tilt the fork (7) to the right and left, respectively. Such tiltability of the fork (7) can provide the vehicle (1) with greater maneuverability and versatility.

Rotation of the fork (7) about the fork rotation axis (31) can be actuated by a by a powered fork second driver (not shown) which drives the fork (7) to tilt to the right and left. As to particular embodiments, the fork second driver can be configured as a hydraulic system including hydraulic fluid supplied by a hydraulic reservoir and pressurized by a hydraulic pump. The pressurized hydraulic fluid can be pumped to a hydraulic cylinder to actuate tilting of the fork (7) to the right and left.

As to particular embodiments, rotation of the fork (7) about the fork rotation axis (31) can be actuated by a double-acting hydraulic cylinder which uses hydraulic pressure to move a piston in two directions for both extension and retraction. Supply lines, pressure regulators, valves, etc. may be included in the hydraulic system, as required.

As to particular embodiments, the prongs (8) of the fork (7) can be laterally movable such that the prongs (8) can be moved closer together or farther apart to accommodate the shape and/or dimensions of the load (not shown).

Now referring primarily to FIGS. 2A through 3B, along with a movable fork (7), the inventive vehicle (1) can further include a movable upright (3); correspondingly, the upright (3) can be movably coupled to the base (2) such that the upright (3) can translationally move upwardly and downwardly relative to the base (2) and correspondingly, along the Y axis (6). In this way, the upright (3) can be raised or moved in the +Y direction (as shown in FIGS. 2B and 3B) and lowered or moved in the −Y direction to an upright lower position (32) (as shown in FIGS. 2A and 3A) with respect to the ground (5).

When lowered to the upright lower position (32) in which the upright bottom end (22) contactingly engages with the ground (5) (as shown in FIGS. 2A and 3A), the upright (3) can function as a movable ground-engaging stabilizer capable of stabilizing the vehicle (1), particularly a loaded vehicle (1). As the upright (3) can be proximate the base front end (16) and centrally located between the laterally spaced-apart track assemblies (10), when engaged with the ground (5), such a stabilizer can prevent the vehicle (1) from tipping in the direction of the loaded fork (7). Further, as a result of such a stabilizer, a counterweight may not be needed or not as much counterweight may be needed to balance the weight of the load.

Distinctively, as to particular embodiments, the inventive vehicle (1) can include only one movable ground-engaging stabilizer (provided by the upright (3)) which can be centrally located proximate the base (2) as well as proximate the footprint of the vehicle (1). This may be in contrast to conventional vehicles configured for lifting and/or transporting loads, which may employ multiple extensible outriggers which can outwardly extend therefrom for stability.

As to particular embodiments, the inventive vehicle (1) can include only one movable ground-engaging stabilizer consisting of the upright (3).

To function as a stabilizer, as to particular embodiments, the upright (3) can be slidably coupled to the base (2) such that the upright (3) can slide upwardly and downwardly relative to the base (2) for raising and lowering with respect to the ground (5). For such sliding movement, the upright (3) can include one or more upright guides (33) disposed along the upright length (20). As to particular embodiments, the upright (3) can include a pair of upright guides (33) disposed along the upright length (20) in substantially parallel spaced-apart relation, whereby the upright guides (33) can extend in substantially parallel relation to the Y axis (6). Hence, the upright (3) can be configured to have a pair of opposing second elongate members (34), each including an upright guide (33) disposed along its length. As but one illustrative, nonlimiting example, each second elongate member (34) can have a generally rectangular, C-shaped cross section with the open side providing an upright guide (33) configured as a second channel, whereby the second channels of each of the two second elongate members (34) can face away from one another. Of course, inwardly, frontwardly, and backwardly facing channels are also herein contemplated.

As to particular embodiments, the upright (3) can be movably coupled to the base (2) via an upright support (35) disposed therebetween, whereby the upright (3) can be movably coupled to the upright support (35) (such as via a bracket (36)). As to particular embodiments, the upright support (35) can be mounted on the base (2) proximate base front end (16).

The upright (3) can be slidably coupled to the second channels via second bearings (37) or other suitable couplers which travel within the second channels to enable translational movement of the upright (3) to raise the upright (3) via upward movement or lower the upright (3) via downward movement to the upright lower position (32) to contactingly engage with the ground (5) for stabilization of the vehicle (1). Such translational movement of the upright (3) can be actuated by a powered upright first driver (38) which drives the upright (3) to slide via the second channels along the Y axis (6). As to particular embodiments, the upright first driver (38) can be configured as a hydraulic system including hydraulic fluid supplied by a hydraulic reservoir and pressurized by a hydraulic pump. The pressurized hydraulic fluid can be pumped to a hydraulic cylinder (39) to actuate sliding of the upright (3) relative to the base (2) for movement thereof in the +Y direction or −Y direction.

As to particular embodiments, translational movement of the upright (3) can be actuated by a double-acting hydraulic cylinder which uses hydraulic pressure to move a piston in two directions for both extension and retraction. Supply lines, pressure regulators, valves, etc. may be included in the hydraulic system, as required.

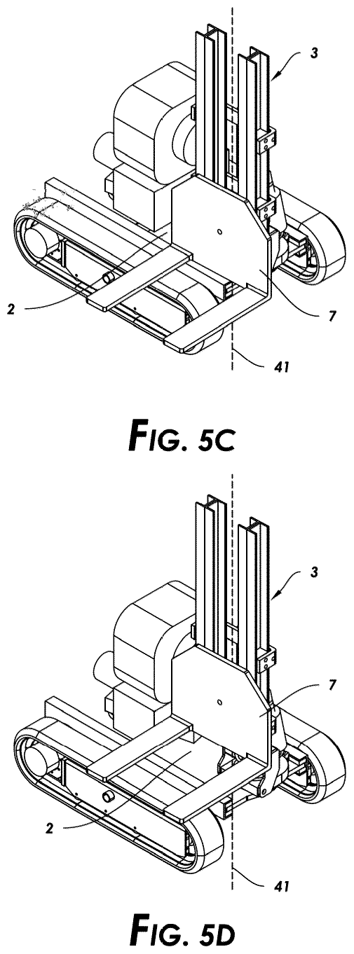

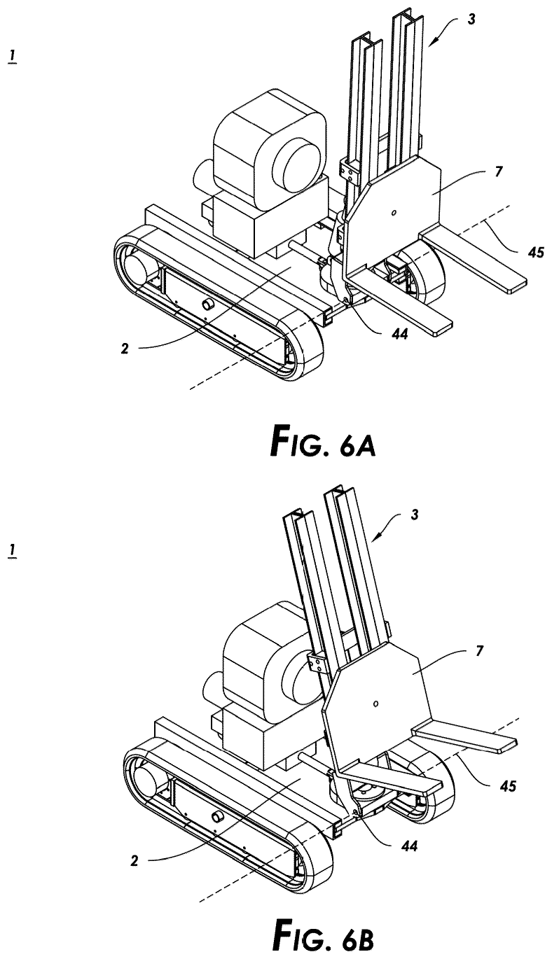

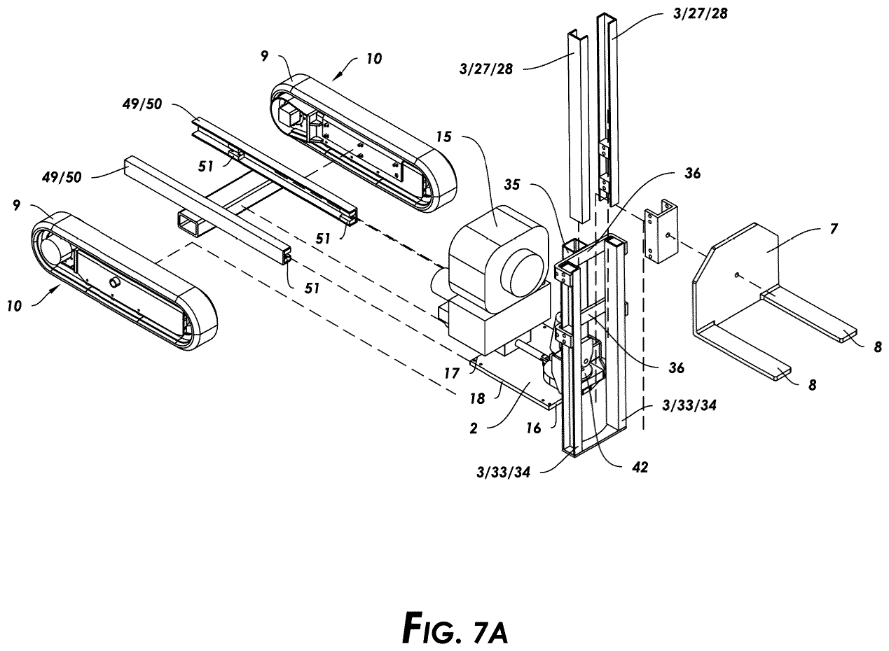

Now referring primarily to FIGS. 5A through 5D, in addition to being movably coupled to the base (2) such that the upright (3) can translationally move upwardly and downwardly relative to the base (2), as to particular embodiments, the upright (3) can further be movably coupled to the base (2) via a second pivot (40) such that the upright (3) can rotate relative to the base (2) about an upright first rotation axis (41) which can typically extend in substantially parallel relation to the upright longitudinal axis (23). Further, the upright first rotation axis (41) can extend in substantially parallel relation to the Y axis (6). As such, the upright (3) can rotate relative to the base (2) about the upright first rotation axis (41) in both clockwise and counterclockwise directions to rotate the upright (3) (and correspondingly, the fork (7)) to the left and right, respectively. Such rotatability of the upright (3) can provide the vehicle (1) with greater maneuverability and versatility.

As to particular embodiments, the upright (3) can be rotatably coupled to the base (2) via the upright support (35) disposed therebetween, whereby the upright support (35) can be rotatably coupled to the base (2) (such as via a rotatable plate (42)).

Rotation of the upright (3) about the upright first rotation axis (41) can be actuated by a powered upright second driver (43) which drives the upright (3) to rotate to the left and right. As to particular embodiments, the upright second driver (43) can be configured as a hydraulic system including hydraulic fluid supplied by a hydraulic reservoir and pressurized by a hydraulic pump. The pressurized hydraulic fluid can be pumped to a hydraulic cylinder (39) to actuate rotation of the upright (3) to the left and right.

As to particular embodiments, rotation of the upright (3) about the upright first rotation axis (41) can be actuated by a double-acting hydraulic cylinder which uses hydraulic pressure to move a piston in two directions for both extension and retraction. Supply lines, pressure regulators, valves, etc. may be included in the hydraulic system, as required.

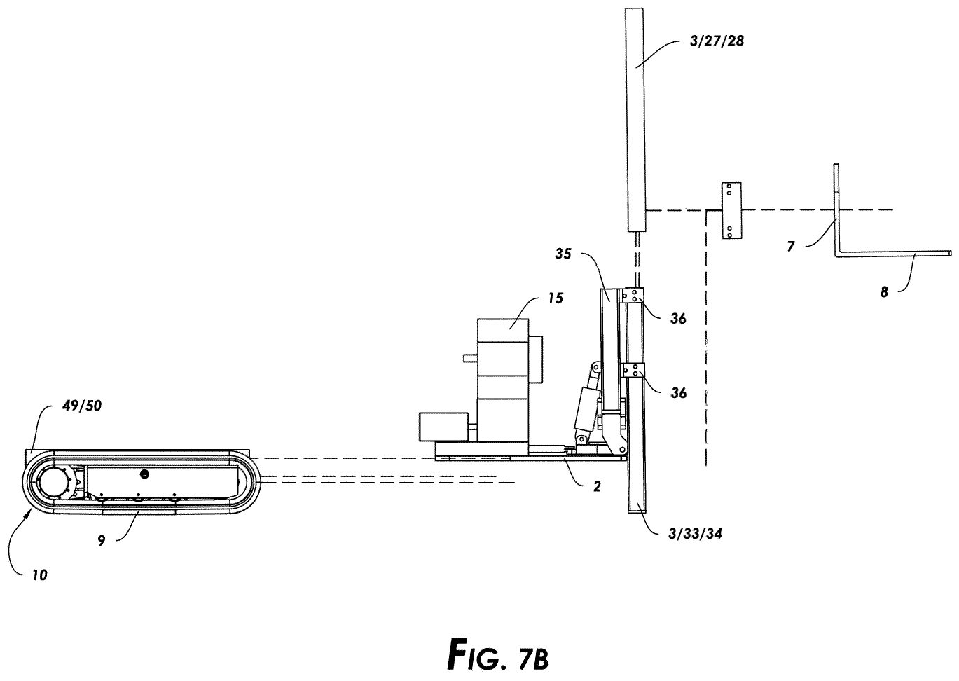

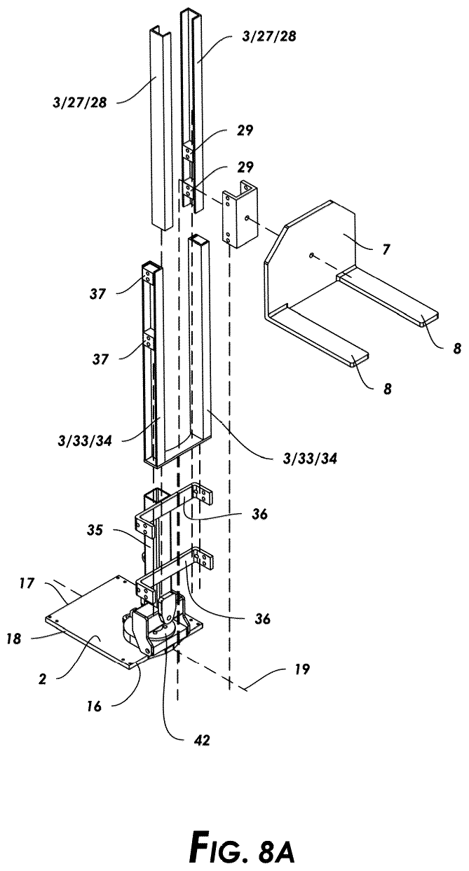

Now referring primarily to FIGS. 6A and 6B, in addition to being movably coupled to the base (2) such that the upright (3) can translationally move upwardly and downwardly relative to the base (2), as to particular embodiments, the upright (3) can further be movably coupled to the base (2) via a third pivot (44) such that the upright (3) can rotate relative to the base (2) about an upright second rotation axis (45) which can typically extend in substantially perpendicular relation to the upright longitudinal axis (23). Further, the upright second rotation axis (43) can extend in substantially parallel relation to a Z axis which extends in substantially perpendicular relation to both the X axis (4) and the Y axis (6). As such, the upright (3) can rotate relative to the base (2) about the upright second rotation axis (45) in both forward and backward directions to tilt the upright (3) (and correspondingly, the fork (7)) forwardly (or in the +X direction) and backwardly (or in the −X direction), respectively. As to particular embodiments, the upright (3) can tilt relative to the base (2) about 20° degrees behind vertical (backwardly) to about 20° degrees in front of vertical (forwardly). Such tiltability of the upright (3) can allow for manipulation of the center of gravity while transporting a load.

Rotation of the upright (3) about the upright second rotation axis (45) can be actuated by a by a powered upright third driver (46) which drives the upright (3) to tilt forwardly and backwardly. As to particular embodiments, the upright third driver (46) can be configured as a hydraulic system including hydraulic fluid supplied by a hydraulic reservoir and pressurized by a hydraulic pump. The pressurized hydraulic fluid can be pumped to a hydraulic cylinder (39) to actuate tilting of the upright (3) forwardly and backwardly.

As to particular embodiments, rotation of the upright (3) about the upright second rotation axis (45) can be actuated by a double-acting hydraulic cylinder which uses hydraulic pressure to move a piston in two directions for both extension and retraction. Supply lines, pressure regulators, valves, etc. may be included in the hydraulic system, as required.

Now referring primarily to FIGS. 2A through 3B, the base (2) can be adjustably coupled to the tracks (9) via the track assemblies (10) such that the base (2) can be positioned forwardly or backwardly relative to the track assemblies (10) between the track assemblies' front and rear ends (11)(12). For such positioning, the base (2) can remain stationary relative to the ground (5), whereby the upright (3) disposed in the upright lower position (32) can serve to anchor the base (2) to the ground (5). Subsequently, the tracks (9) can be driven by the travel driver (15) to drive travel of the track assemblies (10) forwardly or backwardly relative to the stationary base (2) along the X axis (4) to adjust the position the base (2) relative to the track assemblies (10).

In this way, the base (2) can be positioned in a base forward position (47) in which the base front end (16) disposes proximate the track assemblies' front ends (11) and the fork (7) disposes outwardly or forwardly (in a +X direction) from the track assemblies' front ends (11) and correspondingly, outwardly or forwardly from the front of the vehicle (1).

Also in this way, the base (2) can be positioned in a base rearward position (48) in which the base rear end (17) disposes proximate the track assemblies' rear ends (12) and the fork (7) disposes inwardly or backwardly (in a −X direction) from the track assemblies' front ends (11), thus locating the fork (7) within the footprint defined by the pair of track assemblies (10). Consequently, the center of gravity of a loaded vehicle (1) can also be moved from proximate the front of the vehicle (1) to proximate the middle of the vehicle (1) which can increase the stability thereof and prevent the vehicle (1) from tipping in the direction of the loaded fork (7). Further, as a result of such positioning of the base (2), a counterweight may not be needed or not as much counterweight may be needed to balance the weight of the load.

To position the base (2) in the base rearward position (48) from the base forward position (47), the base (2) can be anchored to the ground (5) via the upright (3) disposed in the upright lower position (32) and the track assemblies (10) can travel forwardly in a +X direction until the base rear end (17) disposes proximate the track assemblies' rear ends (12) and the fork (7) is located within the footprint defined by the pair of track assemblies (10). Conversely, to position the base (2) in the base forward position (47) from the base rearward position (48), the base (2) can be anchored to the ground (5) via the upright (3) disposed in the upright lower position (32) and the track assemblies (10) can travel backwardly in a −X direction until the base front end (16) disposes proximate the track assemblies' front ends (11) and the fork (7) outwardly extends from the front of the vehicle (1).

Thus, the base (2) can be adjustably coupled to the track assemblies (10) such that the base (2) can be positioned forwardly or backwardly relative to the track assemblies (10) for moving the center of gravity of the loaded vehicle (1). For such positioning, each track assembly (10) can include a base guide (49) fixedly coupled thereto between the track assembly front and rear ends (11)(12). Thus, a pair of base guides (49) can be disposed in substantially parallel spaced-apart relation and extend in substantially parallel relation to the X axis (4). As to particular embodiments, the base guides (49) can be disposed along a pair of opposing third elongate members (50), each elongate member (50) extending along its track assembly (10) between the track assembly front and rear ends (11)(12). As but one illustrative, nonlimiting example, each third elongate member (50) can have a generally rectangular, C-shaped cross section with the open side providing a base guide (49) configured as a third channel, whereby the third channels of each of the two third elongate members (50) can face toward one another. Of course, outwardly, upwardly, and downwardly facing third channels are also herein contemplated.

The base (2) can be slidably coupled to the third channels via third bearings (51) or other suitable couplers which travel within the third channels to position the base (2) forwardly or backwardly relative to the track assemblies (10) to locate the center of gravity of the loaded vehicle (1) from proximate the front of the vehicle (1) to proximate the middle of the vehicle (1) for increased stability thereof. Such positioning of the base (2) relative to the track assemblies (10) can be actuated by a driver (not shown).

Now regarding use, as but one illustrative example of a method of using the inventive vehicle (1) for transporting a load can include approaching the load with (i) the base (2) in the base forward position (47), (ii) the upright (3) raised above the ground (5), and (iii) the fork (7) lowered. The fork (7) can then supportingly engage with the load. The upright (3) can then be lowered to the upright lower position (32) in which the upright bottom end (22) contactingly engages with the ground (5) to function as a movable ground-engaging stabilizer which anchors the base (2) to the ground (5) and stabilizes the loaded vehicle (1). The fork (7) can then be raised to lift the load. The tracks (9) can then be driven by the travel driver (15) to drive travel of the track assemblies (10) forwardly in the +X direction to position the stationary base (2) in the base rearward position (48) to locate the center of gravity of the loaded vehicle (1) from proximate the front of the vehicle (1) to proximate the middle of the vehicle (1) for increased stability thereof. The upright (3) can then be raised above the ground (5), and the vehicle (1) can transport the load from one location to another location. Once arrived, the upright (3) can then be lowered to the upright lower position (32) to anchor the base (2) to the ground (5) and stabilize the loaded vehicle (1). The tracks (9) can then be driven by the travel driver (15) to drive travel of the track assemblies (10) backwardly in the −X direction until the loaded fork (7) outwardly extends from the front of the vehicle (1). The fork (7) can then be lowered to unload the load.

As to particular embodiments, the method of use can further include tilting the fork (7) to the right or the left.

As to particular embodiments, the method of use can further include rotating the fork (7) to the right or the left.

As to particular embodiments, the method of use can further include tilting the fork (7) forwardly or backwardly.

Now regarding manufacturing, the structural components of the vehicle (1) can be made from steel or other materials which give the structures suitable mechanical properties mainly as related to loading capacity and bending strength. The structural components can be attached by welding, nuts and bolts, or the like, as mandated by manufacturing and ease of assembly. The structural components can be arranged as disclosed herein or in different positions, depending upon the embodiment.

In addition to being configured as described above, the drivers could be replaced by other components having the same function.

The figures represents a particular embodiment of the present invention and show only the mechanical structures of the vehicle (1) which are useful for comprehending the inventive vehicle (1); the figures do not represent, nor is a description given of, the other components that necessarily complete a vehicle (1), such as a braking system, mechanical transmissions, electric systems, control systems (such as a motor control circuit, a power control circuit, and a hydraulic control circuit), etc.

As can be easily understood from the foregoing, the basic concepts of the present invention may be embodied in a variety of ways. The invention involves numerous and varied embodiments of a load transport system and methods of making and using the same.

As such, the particular embodiments or elements of the invention disclosed by the description or shown in the figures or tables accompanying this application are not intended to be limiting, but rather exemplary of the numerous and varied embodiments generically encompassed by the invention or equivalents encompassed with respect to any particular element thereof. In addition, the specific description of a single embodiment or element of the invention may not explicitly describe all embodiments or elements possible; many alternatives are implicitly disclosed by the description and figures.

It should be understood that each element of an apparatus or each step of a method may be described by an apparatus term or method term. Such terms can be substituted where desired to make explicit the implicitly broad coverage to which this invention is entitled. As but one example, it should be understood that all steps of a method may be disclosed as an action, a means for taking that action, or as an element which causes that action. Similarly, each element of an apparatus may be disclosed as the physical element or the action which that physical element facilitates. As but one example, the disclosure of a “driver” should be understood to encompass disclosure of the act of “driving”—whether explicitly discussed or not—and, conversely, were there effectively disclosure of the act of “driving,” such a disclosure should be understood to encompass disclosure of a “driver” and even a “means for driving.” Such alternative terms for each element or step are to be understood to be explicitly included in the description.

In addition, as to each term used it should be understood that unless its utilization in this application is inconsistent with such interpretation, common dictionary definitions should be understood to be included in the description for each term as contained in the Random House Webster's Unabridged Dictionary, second edition, each definition hereby incorporated by reference.

All numeric values herein are assumed to be modified by the term “about”, whether or not explicitly indicated. For the purposes of the present invention, ranges may be expressed as from “about” one particular value to “about” another particular value. When such a range is expressed, another embodiment includes from the one particular value to the other particular value. The recitation of numerical ranges by endpoints includes all the numeric values subsumed within that range. A numerical range of one to five includes for example the numeric values 1, 1.5, 2, 2.75, 3, 3.80, 4, 5, and so forth. It will be further understood that the endpoints of each of the ranges are significant both relative to the other endpoint, and independently of the other endpoint. When a value is expressed as an approximation by use of the antecedent “about,” it will be understood that the particular value forms another embodiment. The term “about” generally refers to a range of numeric values that one of skill in the art would consider equivalent to the recited numeric value or having the same function or result. Similarly, the antecedent “substantially” means largely, but not wholly, the same form, manner or degree and the particular element will have a range of configurations as a person of ordinary skill in the art would consider as having the same function or result. When a particular element is expressed as an approximation by use of the antecedent “substantially,” it will be understood that the particular element forms another embodiment.

Moreover, for the purposes of the present invention, the term “a” or “an” entity refers to one or more of that entity unless otherwise limited. As such, the terms “a” or “an”, “one or more” and “at least one” can be used interchangeably herein.

Thus, the applicant(s) should be understood to claim at least: i) each of the load transport systems and corresponding methods herein disclosed and described, ii) the related methods disclosed and described, iii) similar, equivalent, and even implicit variations of each of these devices and methods, iv) those alternative embodiments which accomplish each of the functions shown, disclosed, or described, v) those alternative designs and methods which accomplish each of the functions shown as are implicit to accomplish that which is disclosed and described, vi) each feature, component, and step shown as separate and independent inventions, vii) the applications enhanced by the various systems or components disclosed, viii) the resulting products produced by such systems or components, ix) methods and apparatuses substantially as described hereinbefore and with reference to any of the accompanying examples, x) the various combinations and permutations of each of the previous elements disclosed.

The background section of this patent application, if any, provides a statement of the field of endeavor to which the invention pertains. This section may also incorporate or contain paraphrasing of certain United States patents, patent applications, publications, or subject matter of the claimed invention useful in relating information, problems, or concerns about the state of technology to which the invention is drawn toward. It is not intended that any United States patent, patent application, publication, statement or other information cited or incorporated herein be interpreted, construed or deemed to be admitted as prior art with respect to the invention.

The claims set forth in this specification, if any, are hereby incorporated by reference as part of this description of the invention, and the applicant expressly reserves the right to use all of or a portion of such incorporated content of such claims as additional description to support any of or all of the claims or any element or component thereof, and the applicant further expressly reserves the right to move any portion of or all of the incorporated content of such claims or any element or component thereof from the description into the claims or vice-versa as necessary to define the matter for which protection is sought by this application or by any subsequent application or continuation, division, or continuation-in-part application thereof, or to obtain any benefit of, reduction in fees pursuant to, or to comply with the patent laws, rules, or regulations of any country or treaty, and such content incorporated by reference shall survive during the entire pendency of this application including any subsequent continuation, division, or continuation-in-part application thereof or any reissue or extension thereon.

Additionally, the claims set forth in this specification, if any, are further intended to describe the metes and bounds of a limited number of the preferred embodiments of the invention and are not to be construed as the broadest embodiment of the invention or a complete listing of embodiments of the invention that may be claimed. The applicant does not waive any right to develop further claims based upon the description set forth above as a part of any continuation, division, or continuation-in-part, or similar application.

1. A vehicle comprising:
a propulsion mechanism operable to propel said vehicle for travel thereof;
a base coupled to said propulsion mechanism;
an upright movably coupled to said base, said upright movable upwardly and downwardly relative to said base; and
an engagement element movably coupled to said upright, said engagement element movable upwardly and downwardly relative to said upright.

2. The vehicle of claim 1, wherein said vehicle is configured as a forklift.

3. The vehicle of claim 2, wherein said engagement element comprises a fork having one or more prongs suitable for engaging with a load.

4. The vehicle of claim 2, wherein said forklift is configured for use with prefabricated buildings.

5. The vehicle of claim 2, wherein said forklift comprises an unmanned forklift.

6. The vehicle of claim 5, further comprising a remote control system for remotely controlling said forklift.

7. The vehicle of claim 1, wherein said engagement element comprises one or more grips suitable for engaging with a load.

8. The vehicle of claim 1, wherein said engagement element comprises one or more hooks suitable for engaging with a load.

9. The vehicle of claim 1, wherein said engagement element comprises one or more magnets suitable for engaging with a load.

10. The vehicle of claim 1, wherein said propulsion mechanism comprises one or more tracks.

11. The vehicle of claim 1, wherein said propulsion mechanism comprises one or more wheels.

12. The vehicle of claim 3, wherein said base comprises a base length disposed between a base front end and a base rear end.

13. The vehicle of claim 12, wherein said fork disposes proximate said base front end.

14. The vehicle of claim 13, wherein said upright disposes proximate said base front end.

15. The vehicle of claim 14, wherein said upright comprises a fork guide disposed along an upright length for translational movement of said fork along said upright.

16. The vehicle of claim 15, wherein said upright comprises a pair of said fork guides disposed along said upright length in substantially parallel spaced-apart relation.

17. The vehicle of claim 15, wherein said translational movement of said fork is actuated by a fork first driver.

18. The vehicle of claim 17, wherein said fork first driver comprises a hydraulic system.

19. The vehicle of claim 18, wherein said hydraulic system comprises a double-acting hydraulic cylinder.

20. The vehicle of claim 15, wherein said fork is coupled to said upright via a first pivot for rotational movement of said fork relative to said upright.

21. The vehicle of claim 20, wherein said rotational movement of said fork is actuated by a fork second driver.

22. The vehicle of claim 21, wherein said fork second driver comprises a hydraulic system.

23. The vehicle of claim 22, wherein said hydraulic system comprises a double-acting hydraulic cylinder.

24. The vehicle of claim 13, wherein said prongs of said fork are laterally moveable.

25. The vehicle of claim 1, wherein when said upright disposes in an upright lower position, an upright bottom end of said upright contactingly engages with the ground such that said upright functions as a movable ground-engaging stabilizer capable of stabilizing said vehicle.

26. The vehicle of claim 25, further comprising only one said movable ground-engaging stabilizer consisting of said upright.

27. The vehicle of claim 14, wherein said upright comprises an upright guide disposed along an upright length for translational movement of said upright relative to said base.

28. The vehicle of claim 27, wherein said upright comprises a pair of said upright guides disposed along said upright length in substantially parallel spaced-apart relation.

29. The vehicle of claim 27, wherein said translational movement of said upright is actuated by an upright first driver.

30. The vehicle of claim 29, wherein said upright first driver comprises a hydraulic system.

31. The vehicle of claim 30, wherein said hydraulic system comprises a double-acting hydraulic cylinder.

32. The vehicle of claim 27, wherein said upright is coupled to said base via a second pivot for rotational movement of said upright relative to said base about an upright first rotation axis.

33. The vehicle of claim 32, wherein said rotational movement of said upright about said upright first rotation axis is actuated by an upright second driver.

34. The vehicle of claim 33, wherein said upright second driver comprises a hydraulic system.

35. The vehicle of claim 34, wherein said hydraulic system comprises a double-acting hydraulic cylinder.

36. The vehicle of claim 32, wherein said upright is coupled to said base via a third pivot for rotational movement of said upright relative to said base about an upright second rotation axis.

37. The vehicle of claim 36, wherein said rotational movement of said upright about said upright second rotation axis is actuated by an upright third driver.

38. The vehicle of claim 37, wherein said upright third driver comprises a hydraulic system.

39. The vehicle of claim 38, wherein said hydraulic system comprises a double-acting hydraulic cylinder.

40. The vehicle of claim 10, wherein said base is adjustably coupled to said tracks such that said base is positionable forwardly or backwardly relative to said tracks.

41. The vehicle of claim 40, wherein said base is adjustably coupled to said tracks via a base guide.

42. The vehicle of claim 41, wherein said base is adjustably coupled to said tracks via a pair of said base guides disposed in substantially parallel spaced-apart relation.

43. A method of making a vehicle for transporting a load, comprising:
providing a propulsion mechanism operable to propel said vehicle for travel thereof;
coupling a base to said propulsion mechanism;
movably coupling an upright to said base, said upright movable upwardly and downwardly relative to said base; and
movably coupling an engagement element to said upright, said engagement element movable upwardly and downwardly relative to said upright.

44. The method of claim 43, wherein said vehicle is configured as a forklift.

45. The method of claim 44, wherein said engagement element comprises a fork having one or more prongs suitable for engaging with a load.

46. The method of claim 44, wherein said forklift is configured for use with prefabricated buildings.

47. The method of claim 44, wherein said forklift comprises an unmanned forklift.

48. The method of claim 47, further comprising operably coupling a remote control system to said forklift for remotely controlling said forklift.

49. The method of claim 43, wherein said engagement element comprises one or more grips suitable for engaging with a load.

50. The method of claim 43, wherein said engagement element comprises one or more hooks suitable for engaging with a load.

51. The method of claim 43, wherein said engagement element comprises one or more magnets suitable for engaging with a load.

52. The method of claim 43, wherein said propulsion mechanism comprises one or more tracks.

53. The method of claim 43, wherein said propulsion mechanism comprises one or more wheels.

54. The method of claim 45, wherein said base comprises a base length disposed between a base front end and a base rear end.

55. The method of claim 54, further comprising disposing said fork proximate said base front end.

56. The method of claim 55, further comprising disposing said upright proximate said base front end.

57. The method of claim 56, further comprising disposing a fork guide along an upright length for translational movement of said fork along said upright.

58. The method of claim 57, further comprising disposing a pair of said fork guides along said upright length in substantially parallel spaced-apart relation.

59. The method of claim 57, wherein said translational movement of said fork is actuated by a fork first driver.

60. The method of claim 59, wherein said fork first driver comprises a hydraulic system.

61. The method of claim 60, wherein said hydraulic system comprises a double-acting hydraulic cylinder.

62. The method of claim 57, further comprising coupling said fork to said upright via a first pivot for rotational movement of said fork relative to said upright.

63. The method of claim 62, wherein said rotational movement of said fork is actuated by a fork second driver.

64. The method of claim 63, wherein said fork second driver comprises a hydraulic system.

65. The method of claim 64, wherein said hydraulic system comprises a double-acting hydraulic cylinder.

66. The method of claim 55, wherein said prongs of said fork are laterally moveable.

67. The method of claim 43, wherein when said upright disposes in an upright lower position, an upright bottom end of said upright contactingly engages with the ground such that said upright functions as a movable ground-engaging stabilizer capable of stabilizing said vehicle.

68. The method of claim 67, further comprising only one said movable ground-engaging stabilizer consisting of said upright.

69. The method of claim 56, further comprising disposing an upright guide along an upright length for translational movement of said upright relative to said base.

70. The method of claim 69, further comprising disposing a pair of said upright guides along said upright length in substantially parallel spaced-apart relation.

71. The method of claim 69, wherein said translational movement of said upright is actuated by an upright first driver.

72. The method of claim 71, wherein said upright first driver comprises a hydraulic system.

73. The method of claim 72, wherein said hydraulic system comprises a double-acting hydraulic cylinder.

74. The method of claim 69, further comprising coupling said upright to said base via a second pivot for rotational movement of said upright relative to said base about an upright first rotation axis.

75. The method of claim 74, wherein said rotational movement of said upright about said upright first rotation axis is actuated by an upright second driver.

76. The method of claim 75, wherein said upright second driver comprises a hydraulic system.

77. The method of claim 76, wherein said hydraulic system comprises a double-acting hydraulic cylinder.

78. The method of claim 74, further comprising coupling said upright to said base via a third pivot for rotational movement of said upright relative to said base about an upright second rotation axis.

79. The method of claim 78, wherein said rotational movement of said upright about said upright second rotation axis is actuated by an upright third driver.

80. The method of claim 79, wherein said upright third driver comprises a hydraulic system.

81. The method of claim 80, wherein said hydraulic system comprises a double-acting hydraulic cylinder.

82. The method of claim 52, further comprising adjustably coupling said base to said tracks such that said base is positionable forwardly or backwardly relative to said tracks.

83. The method of claim 82, further comprising adjustably coupling said base to said tracks via a base guide.

84. The method of claim 83, further comprising adjustably coupling said base to said tracks via a pair of said base guides disposed in substantially parallel spaced-apart relation.

85. A method of using a vehicle for transporting a load, comprising:
obtaining said vehicle comprising:
a propulsion mechanism operable to propel said vehicle for travel thereof;
wherein said propulsion mechanism comprises one or more tracks;
a base coupled to said propulsion mechanism;
an upright movably coupled to said base, said upright movable upwardly and downwardly relative to said base; and
an engagement element movably coupled to said upright, said engagement element movable upwardly and downwardly relative to said upright;
wherein said engagement element comprises a fork having one or more prongs suitable for engaging with said load; and
approaching said load with (i) said base in a base forward position, and (ii) said upright raised above the ground.

86. The method of claim 85, further comprising supportingly engaging said fork with said load to provide a loaded fork and a loaded vehicle.

87. The method of claim 86, further comprising lowering said upright to an upright lower position in which an upright bottom end of said upright contactingly engages with said ground to function as a movable ground-engaging stabilizer which anchors said base to said ground and stabilizes said loaded vehicle.

88. The method of claim 87, further comprising raising said fork to lift said load.

89. The method of claim 88, further comprising driving said tracks forwardly in a +X direction to position said base in a base rearward position to locate the center of gravity of said loaded vehicle from proximate a front of said vehicle to proximate a middle of said vehicle for increased stability thereof.

90. The method of claim 89, further comprising raising said upright above said ground.

91. The method of claim 90, further comprising transporting said load from one location to another location.

92. The method of claim 91, further comprising lowering said upright to said upright lower position to anchor said base to said ground and stabilize said loaded vehicle.

93. The method of claim 92, further comprising driving said tracks backwardly in a −X direction until said loaded fork outwardly extends from said front of said vehicle.

94. The method of claim 93, further comprising lowering said fork to unload said load.
